(19) United States
(12) Patent Application Publication
(10) Pub. No.: US 2022/0188982 A1
(43) Pub. Date: Jun. 16, 2022

(54) IMAGE RECONSTRUCTION METHOD AND DEVICE, ELECTRONIC DEVICE, AND STORAGE MEDIUM

(71) Applicant: SHENZHEN SENSETIME TECHNOLOGY CO., LTD., Shenzhen (CN)

(72) Inventors: Shuyang SUN, Shenzhen (CN); Yi ZHOU, Shenzhen (CN); Yikang LI, Shenzhen (CN); Wanli OUYANG, Shenzhen (CN)

(21) Appl. No.: 17/686,277

(22) Filed: Mar. 3, 2022

Related U.S. Application Data
(63) Continuation of application No. PCT/CN2019/119462, filed on Nov. 19, 2019.

(30) Foreign Application Priority Data
Sep. 27, 2019 (CN) 201910923706.8

(51) Int. Cl. G06T 5/00; G06T 5/50; G06T 3/40

(52) U.S. Cl. CPC G06T 5/001; G06T 5/50; G06T 2207/20084; G06T 2207/20221; G06T 3/4053

(57) ABSTRACT

An image reconstruction method includes: an image feature corresponding to a first image in video data and an image feature corresponding to each second image adjacent to the first image are acquired; feature optimization processing is performed on the image feature of the first image and the image feature of the second image to obtain a first optimized feature corresponding to the first image and a second optimized feature corresponding to the second image; feature fusion processing is performed on the first optimized feature and the second optimized feature according to an adjacency matrix between the first optimized feature and the second optimized feature to obtain a fused feature; and image reconstruction processing is performed on the first image using the fused feature to obtain a reconstructed image corresponding to the first image.

### CROSS-REFERENCE TO RELATED APPLICATIONS

This application is a continuation of International Application No. PCT/CN2019/119462, filed on Nov. 19, 2019, which claims priority to Chinese Patent Application No. 201910923706.8, filed on Sep. 27, 2019. The disclosures of International Application No. PCT/CN2019/119462 and Chinese Patent Application No. 201910923706.8 are hereby incorporated by reference in their entireties.

### BACKGROUND

An image reconstruction task is an important issue in the field of low-level vision. Image reconstruction refers to reconstructing a sharp and noiseless high-quality image from a noisy and blurred low-quality image. For example, video image denoising, video super-resolution processing or video deblurring may be implemented. Unlike a single image reconstruction task, how to effectively utilize time information of a video (inter-frame information of the video) is the key for the video reconstruction quality.

### SUMMARY

The disclosure relates to the technical field of computer vision, and particularly to an image reconstruction method and device, an electronic device and a storage medium.

The disclosure discloses technical solutions to image processing.

According to a first aspect of the disclosure, an image reconstruction method is provided, which may include the following operations. An image feature corresponding to a first image in video data and an image feature corresponding to each second image adjacent to the first image are acquired. Feature optimization processing is performed on the image feature of the first image and the image feature of the second image to obtain a first optimized feature corresponding to the first image and a second optimized feature corresponding to the second image respectively. Feature fusion processing is performed on the first optimized feature and the second optimized feature according to an adjacency matrix between the first optimized feature and the second optimized feature to obtain a fused feature. Image reconstruction processing is performed on the first image using the fused feature to obtain a reconstructed image corresponding to the first image.

According to a second aspect of the disclosure, an image reconstruction device is provided, which may include a memory storing processor-executable instructions, and a processor. The processor is configured to execute the stored processor-executable instructions to perform operations of: acquiring an image feature corresponding to a first image in video data and an image feature corresponding to each second image adjacent to the first image; performing feature optimization processing on the image feature of the first image and the image feature of the second image to obtain a first optimized feature corresponding to the first image and a second optimized feature corresponding to the second image respectively; performing feature fusion processing on the first optimized feature and the second optimized feature according to an adjacency matrix between the first optimized feature and the second optimized feature to obtain a fused feature; and performing image reconstruction processing on the first image using the fused feature to obtain a reconstructed image corresponding to the first image.

According to a third aspect of the disclosure, a non-transitory computer-readable storage medium is provided. The non-transitory computer-readable storage medium has stored thereon computer-executable instructions that, when executed by a processor, cause the processor to perform operations of: acquiring an image feature corresponding to a first image in video data and an image feature corresponding to each second image adjacent to the first image; performing feature optimization processing on the image feature of the first image and the image feature of the second image to obtain a first optimized feature corresponding to the first image and a second optimized feature corresponding to the second image respectively; performing feature fusion processing on the first optimized feature and the second optimized feature according to an adjacency matrix between the first optimized feature and the second optimized feature to obtain a fused feature; and performing image reconstruction processing on the first image using the fused feature to obtain a reconstructed image corresponding to the first image.

According to a fourth aspect of the disclosure, an image reconstruction device is provided, which may include an acquisition module, an optimization module, an association module and a reconstruction module. The acquisition module may be configured to acquire an image feature corresponding to a first image in video data and an image feature corresponding to each second image adjacent to the first image. The optimization module may be configured to perform feature optimization processing on the image feature of the first image and the image feature of the second image to obtain a first optimized feature corresponding to the first image and a second optimized feature corresponding to the second image respectively. The association module may be configured to perform feature fusion processing on the first optimized feature and the second optimized feature according to an adjacency matrix between the first optimized feature and the second optimized feature to obtain a fused feature. The reconstruction module may be configured to perform image reconstruction processing on the first image using the fused feature to obtain a reconstructed image corresponding to the first image.

According to a fifth aspect of the disclosure, an electronic device is provided, which may include: a processor; and a memory, configured to store instructions executable by the processor. The processor may be configured to call the instruction stored in the memory to perform any method in the first aspect.

According to a sixth aspect of the disclosure, a computer program is provided, which may include a computer-readable code, the computer-readable code running in an electronic device to enable a processor in the electronic device to perform any method in the first aspect.

It is to be understood that the above general description and the following detailed description are only exemplary and explanatory and not intended to limit the disclosure.

According to the following detailed descriptions made to exemplary embodiments with reference to the drawings, other features and aspects of the disclosure may become clear.

### BRIEF DESCRIPTION OF THE DRAWINGS

The accompanying drawings, which are incorporated in and constitute a part of this specification, illustrate embodiments consistent with the disclosure and, together with the specification, serve to describe the technical solutions of the disclosure.

FIG. 1 is a flowchart of an image reconstruction method according to an embodiment of the disclosure.

FIG. 2 is a flowchart of S10 in an image reconstruction method according to an embodiment of the disclosure.

FIG. 3 is a flowchart of S20 in an image reconstruction method according to an embodiment of the disclosure.

FIG. 4 is a flowchart of S21 in an image reconstruction method according to an embodiment of the disclosure.

FIG. 5 is a flowchart of S22 in an image reconstruction method according to an embodiment of the disclosure.

FIG. 6 is a flowchart of S30 in an image reconstruction method according to an embodiment of the disclosure.

FIG. 7 is a structure diagram of a neural network implementing an image reconstruction method according to an embodiment of the disclosure.

FIG. 8 is a block diagram of an image reconstruction device according to an embodiment of the disclosure.

FIG. 9 is a block diagram of an electronic device according to an embodiment of the disclosure.

FIG. 10 is a block diagram of another electronic device according to an embodiment of the disclosure.

### DETAILED DESCRIPTION

Each exemplary embodiment, feature and aspect of the disclosure will be described below with reference to the drawings in detail. The same reference signs in the drawings represent components with the same or similar functions. Although each aspect of the embodiments is shown in the drawings, the drawings are not required to be drawn to scale, unless otherwise specified.

Herein, special term “exemplary” refers to “use as an example, embodiment or description”. Herein, any “exemplarily” described embodiment may not be explained to be superior to or better than other embodiments.

In the disclosure, term “and/or” is only an association relationship describing associated objects and represents that three relationships may exist. For example, A and/or B may represent three conditions: i.e., independent existence of A, existence of both A and B and independent existence of B. In addition, term “at least one” in the disclosure represents any one of multiple or any combination of at least two of multiple. For example, including at least one of A, B or C may represent including any one or more elements selected from a set formed by A, B and C.

In addition, for describing the disclosure better, many specific details are presented in the following specific implementations. It is understood by those skilled in the art that the disclosure may still be implemented even without some specific details. In some examples, methods, means, components and circuits known very well to those skilled in the art are not described in detail, to highlight the subject of the disclosure.

An execution body of an image reconstruction method of the embodiments of the disclosure may be any image processing device. For example, the image reconstruction method may be executed by a terminal device or a server or another processing device. The terminal device may be User Equipment (UE), a mobile device, a user terminal, a terminal, a cell phone, a cordless phone, a Personal Digital Assistant (PDA), a handheld device, a computing device, a vehicle device, a wearable device and the like. The server may include a local server or a cloud server. In some possible implementations, the image reconstruction method may be implemented in a manner that a processor calls a computer-readable instruction stored in a memory.

The image reconstruction method of the embodiments of the disclosure may be applied to image reconstruction processing over an image in a video. For example, image reconstruction may include at least one of denoising, super-resolution or deblurring processing over the image. The image quality of the image in the video may be improved.

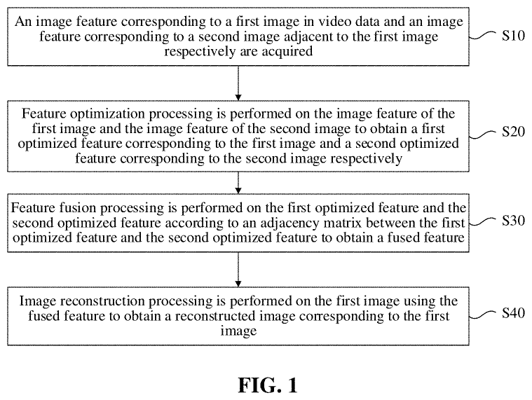

FIG. 1 is a flowchart of an image reconstruction method according to an embodiment of the disclosure. As shown in FIG. 1, the image reconstruction method includes the following steps.

In S10, an image feature corresponding to a first image in video data and an image feature corresponding to each second image adjacent to the first image are acquired.

In some possible implementations, the video data may be video information collected by any collection device, and may include at least two frames of images. In the embodiment of the disclosure, an image to be reconstructed may be called the first image, and an image configured to optimize the first image may be called the second image. The first image and the second image may be adjacent images. In the embodiment of the disclosure, being adjacent may include being directly adjacent or may also include being adjacent at an interval. The fact that the first image and the second image are directly adjacent refers to a fact that the first image and the second image are two images of which a time frame difference is 1 in a video. For example, if the first image is a t-th frame of image, the second image may be a (t−1)th or (t+1)th frame of image, t being an integer more than or equal to 1. The fact that the first image is adjacent to the second image at an interval refers to a fact that the first image and the second image are two images of which a time frame difference is greater than 1 in the video. For example, if the first image is the t-th frame of image, the second image may be a (t+a)th frame of image or a (t−a)th frame of image, a being an integer greater than 1.

In some possible implementations, there may be at least one second image configured to reconstruct the first image. That is, there may be one or more second images. No specific limits are made thereto in the disclosure. In the embodiment of the disclosure, a manner for determining the second image configured to reconstruct the first image may be that the second image is determined according to a preset rule, the preset rule may include the number of the second image and the frame number of the spacing with the first image, and the frame number of the spacing may be a positive number and may also be a negative number. When the frame number is a positive number, it is indicated that a numerical value of a time frame of the second image is greater than a numerical value of a time frame of the first image, and when the frame number of the spacing is a negative number, it is indicated that the numerical value of the time frame of the first image is greater than the numerical value of the time frame of the second image.

In some possible implementations, responsive to that the first image and the second image are determined, the image features of the first image and the second image may be obtained. A pixel value corresponding to at least one pixel in the first image or the second image may be directly determined as the image feature, or feature extraction processing may be performed on the first image and the second image to obtain the image features of the first image and the second image respectively.

In S20, feature optimization processing is performed on the image feature of the first image and the image feature of the second image to obtain a first optimized feature corresponding to the first image and a second optimized feature corresponding to the second image respectively.

In some possible implementations, convolution processing may be performed on the image feature of the first image and the image feature of the second image to implement optimization of each image feature respectively. By such optimization, more detailed feature information may be added, and the richness of the feature may be improved. Optimization processing may be performed on the image features of the first image and the second image to correspondingly obtain the first optimized feature and the second optimized feature respectively. Or, the image features of the first image and the second image may be concatenated to obtain a concatenated feature, feature processing is performed on the concatenated feature to ensure that the image features of the first image and the second image may be fused and simultaneously improve the feature accuracy, and furthermore, convolution is performed on an obtained feature through two convolutional layers to correspondingly obtain the first optimized feature and the second optimized feature respectively.

In S30, feature fusion processing is performed on the first optimized feature and the second optimized feature according to an adjacency matrix between the first optimized feature and the second optimized feature to obtain a fused feature.

In some possible implementations, responsive to that the first optimized feature and the second optimized feature are obtained, the adjacency matrix between the first optimized feature and the second optimized feature may further be obtained. An element in the adjacency matrix identifies an association degree between feature values at the same position in the first optimized feature and the second optimized feature.

In some possible implementations, feature fusion processing may be performed on the first optimized feature and the second optimized feature using an obtained associated feature to obtain the fused feature. By such fusion processing, the image feature of the second image and the image feature of the first image may be effectively fused to facilitate reconstruction of the first image.

In S40, image reconstruction processing is performed on the first image using the fused feature to obtain a reconstructed image corresponding to the first image.

In some possible implementations, responsive to that the fused feature is obtained, image reconstruction may be performed on the first image using the fused feature. For example, addition processing may be performed on the fused feature and the image feature of the first image to obtain a reconstructed image feature. An image corresponding to the reconstructed image feature is the reconstructed image.

It is to be noted herein that the embodiment of the disclosure may be implemented through a neural network and may also be implemented through an algorithm limited in the application and any technical solution in the scope of protection of the application can be considered as an embodiment of the disclosure.

Based on the above configuration, in the embodiment of the application, the adjacency matrix between the first optimized feature and second optimized feature corresponding to the first image and the second image respectively is obtained, the adjacency matrix representing an association between feature information at the same position in the first optimized feature and the second optimized feature, and when the above feature optimization fusion process is executed through the adjacency matrix, inter-frame information between the first image and the second image may be fused according to an association of different features at the same position to further improve an effect of the reconstructed image.

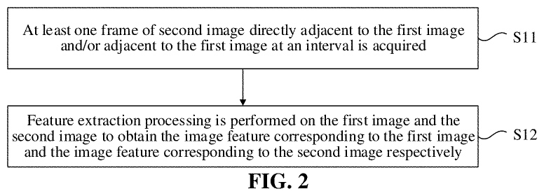

The embodiment of the disclosure will be described below in combination with the drawings in detail. FIG. 2 is a flowchart of S10 in an image reconstruction method according to an embodiment of the disclosure. The operation that the image feature corresponding to the first image in the video data and the image feature corresponding to the second image adjacent to the first image respectively are acquired may include the following steps.

In S11, at least one frame of second image directly adjacent to the first image and/or adjacent to the first image at an interval is acquired.

In some possible implementations, the first image to be reconstructed in the video data and the at least one frame of second image configured to reconstruct the first image may be acquired. The second image may be selected according to the preset rule, or at least one image may be randomly selected from images adjacent to the first image as the second image. No specific limits are made thereto in the disclosure.

In an example, the preset rule may include the number of the second image and the frame number of the spacing with the first image, and the corresponding second image may be determined through the frame number and the number. For example, the preset rule may include that the number of the second image is 1 and the frame number of the spacing with the first image is +1, namely the second image is a next frame of image of the first image. For example, if the first image is the t-th frame of image, the second image is the (t+1)th frame of image. The above is only exemplary description and the second image may also be determined in another manner in another implementation mode.

In S12, feature extraction processing is performed on the first image and the second image to obtain the image feature corresponding to the first image and the image feature corresponding to the second image respectively.

In some possible implementations, pixel values corresponding to the first image and the second image may be directly determined as the image features, or feature extraction processing may also be performed on the first image and the second image through a feature extraction neural network to obtain the corresponding image features respectively. Performing feature extraction processing through the feature extraction neural network may improve the accuracy of the image features. The feature extraction neural network may be a convolutional neural network, and for example, may be a residual network and a feature pyramid network or may also be any other neural network capable of implementing feature extraction. Feature extraction processing may also be implemented through another method in the disclosure, and no specific limits are made thereto.

Responsive to that the image feature of the first image and the image feature of the second image are obtained, feature optimization processing may be performed on the first image and the second image to correspondingly obtain the first optimized feature of the first image and the second optimized feature of the second image respectively. In the embodiment of the disclosure, optimization processing may be performed on the first image and the second image to correspondingly obtain the first optimized feature and the second optimized feature respectively. For example, the image feature of the first image and the image feature of the second image may be processed using a residual network to obtain the first optimized feature of the first image and the second optimized feature of the second image respectively. Or, further convolution processing (for example, at least one layer of convolution processing) may also be continued to be performed on optimized features output by the residual network to obtain the first optimized feature and the second optimized feature.

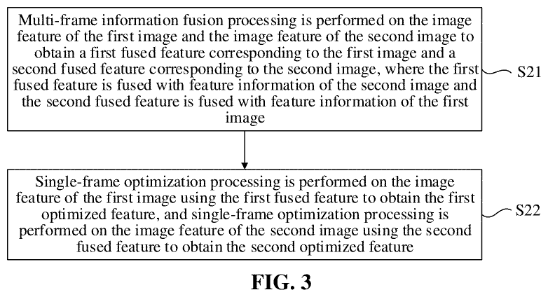

In some possible implementations, each image feature may also be optimized in a manner of fusing the image feature of the first image and the image feature of the second image to correspondingly obtain the first optimized feature and the second optimized feature. FIG. 3 is a flowchart of S20 in an image reconstruction method according to an embodiment of the disclosure.

As shown in FIG. 3, the operation that feature optimization processing is performed on the image feature of the first image and the image feature of the second image to obtain the first optimized feature corresponding to the first image and the second optimized feature corresponding to the second image respectively may include the following steps.

In S21, multi-frame information fusion processing is performed on the image feature of the first image and the image feature of the second image to obtain a first fused feature corresponding to the first image and a second fused feature corresponding to the second image, where the first fused feature is fused with information of the second image and the second fused feature is fused with information of the first image.

In some possible implementations, multi-frame information fusion processing may be performed on the image feature of the first image and the image feature of the second image to obtain the first fused feature corresponding to the first image and the second fused feature corresponding to the second image respectively. By multi-frame information fusion processing, the image features of the first image and the second image may be fused, and furthermore, the first fused feature and the second fused feature include the feature information of the first image and the second image respectively.

In S22, single-frame optimization processing is performed on the image feature of the first image using the first fused feature to obtain the first optimized feature, and single-frame optimization processing is performed on the image feature of the second image using the second fused feature to obtain the second optimized feature.

In some possible implementations, responsive to that the first fused feature of the first image and the second fused feature of the second image are obtained, the first optimized feature and the second optimized feature may be correspondingly obtained by performing single-frame-image feature fusion (i.e., single-frame optimization processing) on the image feature of the first image using the first fused feature and performing single-frame-image feature fusion on the image feature of the second image using the second fused feature respectively. Single-frame optimization processing may further enhance the respective image features based on the first fused feature and the second fused feature such that the obtained first optimized feature simultaneously fuses the feature information of the second image on the basis of including the image feature of the first image and the obtained second optimized feature simultaneously fuses the feature information of the first image on the basis of including the image feature of the second image.

In addition, in the embodiment of the disclosure, the abovementioned optimization processing process may be executed at least once, namely multi-frame information fusion and single-frame optimization processing are executed at least once. The image features of the first image and the second image are directly taken as optimization processing objects during first optimization processing. When multiple optimization processing processes are included, objects of (n+1)th optimization processing are optimized features output by nth optimization processing, that is, multi-frame information fusion and single-frame optimization processing may be continued to be performed on the two optimized features obtained by nth optimization processing to obtain final optimized features (the first optimized feature and the second optimized feature). Performing optimization processing for many times may further improve the accuracy of the obtained feature information and the richness of the features.

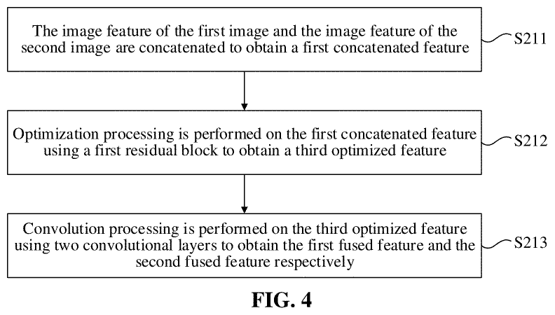

Multi-frame information fusion and single-frame optimization processing will be described below respectively. FIG. 4 is a flowchart of S21 in an image reconstruction method according to an embodiment of the disclosure. As shown in FIG. 4, the operation that multi-frame information fusion processing is performed on the image feature of the first image and the image feature of the second image to obtain the first fused feature corresponding to the first image and the second fused feature corresponding to the second image may include the following steps.

In S211, the image feature of the first image and the image feature of the second image are concatenated to obtain a first concatenated feature.

In some possible implementations, in the process of performing multi-frame information fusion, the image feature of the first image and the image feature of the second image may be concatenated at first, for example, concatenated in a channel direction, to obtain the first concatenated feature. For example, the image feature of the first image and the image feature of the second image may be concatenated using a concat function (concatenation function) to simply fuse information of the two frames of images.

In S212, optimization processing is performed on the first concatenated feature using a first residual block to obtain a third optimized feature.

In some possible implementations, responsive to that the first concatenated feature is obtained, optimization processing may further be performed on the first concatenated feature. In the embodiment of the disclosure, feature optimization processing may be performed using the residual network. The first concatenated feature may be input to the first residual block, and feature optimization is performed to obtain the third optimized feature. By processing through the first residual block, the feature information in the first concatenated feature may be further fused, and the accuracy of the feature information is improved, namely the third optimized feature further accurately fuses the feature information in the first image and the second image.

In S213, convolution processing is performed on the third optimized feature using two convolutional layers to obtain the first fused feature and the second fused feature respectively.

In some possible implementations, responsive to that the third optimized feature is obtained, convolution processing may be performed on the third optimized feature using different convolutional layers respectively. For example, convolution processing may be performed on the third optimized feature using the two convolutional layers to obtain the first fused feature and the second fused feature respectively. The two convolutional layers may be, but not limited to, 1*1 convolution kernels. The first fused feature includes the feature information of the second image and the second fused feature also includes the feature information of the first image, namely each of the first fused feature and the second fused feature includes the feature information of the two images.

Through the above configuration, multi-frame-image feature information fusion of the first image and the second image may be implemented, and the image reconstruction accuracy may be improved in an inter-frame information fusion manner

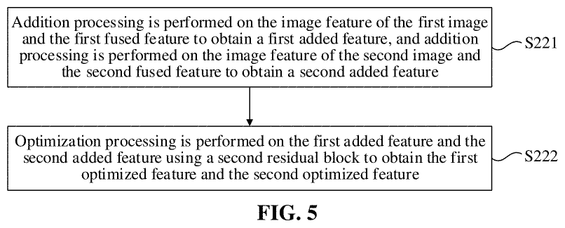

After multi-frame-image inter-frame information fusion processing is performed, single-frame-image feature optimization processing may further be performed. FIG. 5 is a flowchart of S22 in an image reconstruction method according to an embodiment of the disclosure. The operation that single-frame optimization processing is performed on the image feature of the first image using the first fused feature to obtain the first optimized feature and single-frame optimization processing is performed on the image feature of the second image using the second fused feature to obtain the second optimized feature may include the following steps.

In S221, addition processing is performed on the image feature of the first image and the first fused feature to obtain a first added feature, and addition processing is performed on the image feature of the second image and the second fused feature to obtain a second added feature.

In some possible implementations, responsive to that the first fused feature is obtained, single-frame information optimization processing may be performed on the first image using the first fused feature. In the embodiment of the disclosure, such optimization processing may be performed in a manner of adding the image feature of the first image and the first fused feature. Such addition may include direct addition of the first fused feature and the image feature of the first image, and may also include weighted addition of the first fused feature and the image feature of the first image, namely the first fused feature and the image feature of the first image are multiplied by corresponding weighting coefficients respectively and then an addition operation is executed. The weighting coefficient may be a preset numerical value and may also be a numerical value learned by the neural network. No specific limits are made thereto in the disclosure.

Similarly, responsive to that the second fused feature is obtained, single-frame information optimization processing may be performed on the second image using the second fused feature. In the embodiment of the disclosure, such optimization processing may be performed in a manner of adding the image feature of the second image and the second fused feature. Such addition may include direct addition of the second fused feature and the image feature of the second image, and may also include weighted addition of the second fused feature and the image feature of the second image, namely the second fused feature and the image feature of the second image are multiplied by corresponding weighting coefficients respectively and then the addition operation is executed. The weighting coefficient may be a preset numerical value and may also be a numerical value learned by the neural network. No specific limits are made thereto in the disclosure.

It is to be noted herein that, in the embodiment of the disclosure, time for addition processing of the image feature of the first image and the first fused feature and time for addition processing of the image feature of the second image and the second fused feature are not specifically limited and the two operations may be executed respectively and may also be executed simultaneously.

Through the addition processing, the feature information of the original image may further be added based on the fused feature. By single-frame information optimization, feature information of a single frame of image may be preserved in each stage of the network, and furthermore, information of a single frame may be optimized according to optimized information of multiple frames. In addition, in the embodiment of the disclosure, the first added feature and the second added feature may be directly determined as the first optimized feature and the second optimized feature, or subsequent optimization processing may be performed to further improve the feature accuracy.

In S222, optimization processing is performed on the first added feature and the second added feature using a second residual block to obtain the first optimized feature and the second optimized feature.

In some possible implementations, responsive to that the first added feature and the second added feature are obtained, optimization processing may further be performed on the first added feature and the second added feature. For example, convolution processing may be performed on the first added feature and the second added feature to obtain the first optimized feature and the second optimized feature respectively. In the embodiment of the disclosure, for effectively improving fusion and accuracy of the feature information, optimization processing is performed on the first added feature and the second added feature through a residual network respectively. Herein, the residual network is called the second residual block. Processing such as coding convolution and decoding convolution is performed on the first added feature and the second added feature through the second residual block to further optimize and fuse feature information in the first added feature and the second added feature to obtain the first optimized feature corresponding to the first added feature and the second optimized feature corresponding to the second added feature respectively.

Through the abovementioned implementation mode, multi-frame information fusion and single-frame information optimization processing of the first image and the second image may be implemented, so that feature information of other images may further be fused on the basis of improving the accuracy of the feature information of the first image, and the accuracy of the reconstructed image may be improved by inter-frame information fusion.

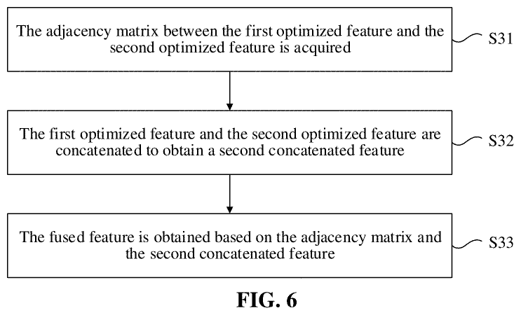

After the image features are optimized, the association between the optimized features may further be obtained, and image reconstruction may further be implemented according to the association. FIG. 6 is a flowchart of S30 in an image reconstruction method according to an embodiment of the disclosure.

As shown in FIG. 6, the operation that feature fusion processing is performed on the first optimized feature and the second optimized feature according to the adjacency matrix between the first optimized feature and the second optimized feature to obtain the fused feature includes the following steps.

In S31, the adjacency matrix between the first optimized feature and the second optimized feature is acquired.

In some possible implementations, responsive to that the first optimized feature corresponding to the first image and the second optimized feature corresponding to the second image are obtained, the adjacency matrix between the first optimized feature and the second optimized feature may further be obtained. The adjacency matrix may represent an association degree between the feature information corresponding to the same position in the first optimized feature and the second optimized feature. The association degree may reflect a change condition of the same object or target person in the first image and the second image. In the embodiment of the disclosure, scales of the first image and the second image may be the same, and correspondingly, scales of the obtained first optimized feature and second optimized feature are also the same.

Even though the obtained first optimized feature and second optimized feature, or the first fused feature and the second fused feature, the first added feature and the second added feature, and the image feature of the first image and the image feature of the second image are different in scale respectively, the corresponding features may also be regulated to the same scale. For example, a scale regulation operation is executed by pooling processing.

In addition, in the embodiment of the disclosure, the adjacency matrix between the first optimized feature and the second optimized feature may be obtained through a graph convolutional neural network, namely the first optimized feature and the second optimized feature may be input to the graph convolutional neural network, and the first optimized feature and the second optimized feature are processed through the graph convolutional neural network to obtain the adjacency matrix therebetween.

In S32, the first optimized feature and the second optimized feature are concatenated to obtain a second concatenated feature.

In some possible implementations, in the process of performing fusion processing on the first optimized feature and the second optimized feature, the first optimized feature and the second optimized feature may be concatenated, for example, the first optimized feature and the second optimized feature are concatenated in the channel direction. In the embodiment of the disclosure, such a concatenation process may be executed through the concat function to obtain the second concatenated feature.

In addition, in the embodiment of the disclosure, an execution step of S31 and S32 may not be limited, and the two steps may be executed simultaneously and may also be executed respectively.

In S33, the fused feature is obtained based on the adjacency matrix and the second concatenated feature.

In some possible implementations, responsive to that the adjacency matrix and the second concatenated feature are obtained, the adjacency matrix may be processed using an activation function. The activation function may be a softmax function. The association degree in the adjacency matrix may be determined as an input parameter, and at least one input parameter is further processed using the activation function to output a processed adjacency matrix.

Furthermore, in the embodiment of the disclosure, the fused feature may be obtained using a product of the adjacency matrix subjected to activation processing of the activation function and the second concatenated feature.

Based on the abovementioned embodiment, the feature information at the same position in multiple frames of images may be fused through the adjacency matrix.

Responsive to that the fused feature is obtained, reconstruction processing may further be performed on the first image using the fused feature. Addition processing may be performed on the image feature of the first image and the fused feature to obtain the image feature corresponding to the reconstructed image, and the reconstructed image may further be determined according to the image feature of the reconstructed image. Addition processing may be direct addition and may also be weighted addition based on the weighting coefficients. No specific limits are made thereto in the disclosure. The image feature of the reconstructed image may directly correspond to a pixel value of at least one pixel of the reconstructed image, so that the reconstructed image may be correspondingly obtained by direct use of the image feature of the reconstructed image. In addition, convolution processing may further be performed on the image feature of the reconstructed image to further fuse the feature information and simultaneously improve the feature accuracy, and then the reconstructed image is determined according to a feature obtained by convolution processing.

The image reconstruction method of the embodiment of the disclosure may be adopted to implement at least one of denoising, super-resolution processing or deblurring of the image, and the image quality may be improved to different extents by image reconstruction. Responsive to that super-resolution processing is performed on the image, the operation that the image feature corresponding to the first image in the video data and the image feature corresponding to the second image adjacent to the first image respectively are acquired may include the following operations.

Upsampling processing is performed on the first image and the second image.

Feature extraction processing is performed on the first image and second image subjected to upsampling processing to obtain the image feature corresponding to the first image and the image feature corresponding to the second image respectively.

That is, in the embodiment of the disclosure, in an image reconstruction process, upsampling processing may be performed on the first image and the second image at first. For example, upsampling processing may be performed by performing convolution processing at least once, or upsampling may be performed in an interpolation fitting manner By upsampling processing, the feature information in the image may further be enriched. In addition, after upsampling processing is performed on the first image and the second image, feature optimization processing and subsequent feature fusion and image reconstruction processing may be performed on the upsampled first image and second image using the image reconstruction method of the embodiment of the disclosure. Through the above configuration, the image accuracy of the reconstructed image may further be improved.

In the embodiment of the disclosure, optimization processing may be performed on the image feature of the first image and the image feature of the second image in the video data to obtain the first optimized feature corresponding to the first image and the second optimized feature corresponding to the second image, feature fusion is performed on the first optimized feature and the second optimized feature using the adjacency matrix between the first optimized feature and the second optimized feature, and reconstruction is performed using the obtained fused feature to obtain the reconstructed image. The adjacency matrix obtained through the first optimized feature and the second optimized feature may represent the association between the feature information at the same position in the first optimized feature and the second optimized feature, and when the above feature optimization fusion process is executed through the adjacency matrix, inter-frame information may be fused according to an association of different features at the same position to further achieve a better effect of the obtained reconstructed image.

In addition, for clearly describing the embodiment of the disclosure, descriptions will be made below with an example. In the image of the disclosure, a reconstruction process of an image in a video may include the following process.

1: Multi-frame information mixing path: information of multiple frames is simply fused in a concatenation (concat) manner at first, and then is converted to a single-frame information space for output after being optimized through a convolutional layer.

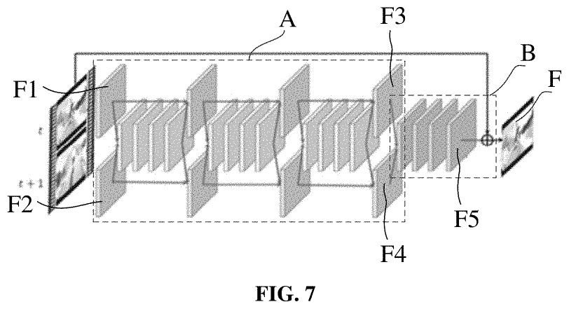

FIG. 7 is a structure diagram of a neural network implementing an image reconstruction method according to an embodiment of the disclosure. As shown in FIG. 7, a t-th frame of image and a (t+1)th frame of image in video data are obtained at first. A network part A in the neural network is correspondingly configured to implement feature optimization processing of image features, and a network part B is configured to implement feature fusion processing and image reconstruction processing.

An input of the neural network may be feature information (image feature) F1 of the t-th frame and feature information (image feature) F2 of the (t+1)th frame, or may also directly be the t-th frame of image and the (t+1)th frame of image.

An output is optimized multi-frame fused information (first fused feature) corresponding to the t-th frame of image and optimized multi-frame fused information (second fused feature) corresponding to the (t+1)th frame.

A Fusion Method

The image feature information of the two frames of images is simply concatenated and fused using a concat function at first, then the fused information is optimized through a residual block, and the optimized fused information is processed through two 1*1 convolutional layers to obtain respective optimized information of the two corresponding frames respectively.

2: Single-frame information self-refining path: the feature information of a single frame is preserved in each stage of the network, and then the information of a single frame is optimized according to optimized information of multiple frames.

For example, for the t-th frame, after information (image feature) of the t-th frame in a last stage and the corresponding optimized fused information (first fused feature) are added, optimization is performed through a residual block to obtain a first optimized feature F3. The same processing process is executed on the (t+1)th frame to obtain a second optimized feature F4.

3: A pixel association module: in a final stage (the part B) of the whole model, an adjacency matrix between multiple frames is calculated using the pixel association module, and then the information of the multiple frames is fused according to the adjacency matrix.

Based on a graph convolutional neural network, an adjacency matrix between the first optimized feature of the t-th frame and the second optimized feature of the (t+1)th frame is calculated, and then the feature information of the t-th frame and the feature information of the (t+1)th frame are fused using the adjacency matrix to obtain an optimized fused feature fusing the information of the t-th frame and the information of the (t+1)th frame.

In the embodiment of the disclosure, a concatenation result (a second concatenated feature) of the feature information (the first optimized feature and the second optimized feature) of the two frames is input to a one-Dimensional (1D) convolutional layer to calculate the adjacency matrix. Then, a softmax operation is executed on the adjacency matrix, and a result is multiplied by the concatenation result of the feature information of the two frames to obtain optimized information (fused feature) F5 of the two frames.

4: Skip connection: at the end of the network, the present t-th frame input to the network and the optimized feature information are added through a skip connection to obtain a final reconstructed image.

That is, addition processing may be performed on the fused feature F5 and the image feature F1 of the t-th frame of image to obtain an image feature of the reconstructed image F, and furthermore, the corresponding reconstructed image may be directly obtained.

From the above, in the embodiment of the disclosure, optimization processing may be performed on the image feature of the first image and the image feature of the second image in the video data to obtain the first optimized feature corresponding to the first image and the second optimized feature corresponding to the second image, feature fusion is performed on the first optimized feature and the second optimized feature using the adjacency matrix between the first optimized feature and the second optimized feature, and reconstruction is performed using the obtained fused feature to obtain the reconstructed image. The adjacency matrix obtained through the first optimized feature and the second optimized feature may represent the association between the feature information at the same position in the first optimized feature and the second optimized feature, and when the above feature optimization fusion process is executed through the adjacency matrix, inter-frame information may be fused according to an association of different features at the same position to further achieve a better effect of the obtained reconstructed image. According to the embodiment of the disclosure, not only is the information of a single frame be effectively preserved, but also inter-frame information obtained by multiple fusions is fully utilized.

In addition, in the embodiment of the disclosure, the inter-frame information may be optimized based on a graph convolution manner using the association of the inter-frame information, so that the feature accuracy is further improved.

It can be understood by those skilled in the art that, in the method of the specific implementations, the writing sequence of each step does not mean a strict execution sequence and is not intended to form any limit to the implementation process and a specific execution sequence of each step should be determined by functions and probable internal logic thereof.

It can be understood that each method embodiment mentioned in the disclosure may be combined to form combined embodiments without departing from principles and logics. For saving the space, elaborations are omitted in the disclosure.

In addition, the disclosure also provides an image reconstruction device, an electronic device, a computer-readable storage medium and a program. All of them may be configured to implement any image reconstruction method provided in the disclosure. Corresponding technical solutions and descriptions refer to the corresponding records in the method part and will not be elaborated.

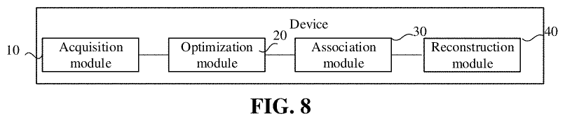

FIG. 8 is a block diagram of an image reconstruction device according to an embodiment of the disclosure. As shown in FIG. 8, the image reconstruction device includes an acquisition module 10, an optimization module 20, an association module 30 and a reconstruction module 40.

The acquisition module 10 is configured to acquire an image feature corresponding to a first image in video data and an image feature corresponding to each second image adjacent to the first image.

The optimization module 20 is configured to perform feature optimization processing on the image feature of the first image and the image feature of the second image to obtain a first optimized feature corresponding to the first image and a second optimized feature corresponding to the second image respectively.

The association module 30 is configured to perform feature fusion processing on the first optimized feature and the second optimized feature according to an adjacency matrix between the first optimized feature and the second optimized feature to obtain a fused feature.

The reconstruction module 40 is configured to perform image reconstruction processing on the first image using the fused feature to obtain a reconstructed image corresponding to the first image.

In some possible implementations, the acquisition module is further configured to acquire at least one frame of second image directly adjacent to the first image and/or adjacent to the first image at an interval; and

perform feature extraction processing on the first image and the second image to obtain the image feature corresponding to the first image and the image feature corresponding to the second image respectively.

In some possible implementations, the optimization module includes a multi-frame fusion unit and a single-frame optimization unit.

The multi-frame fusion unit is configured to perform multi-frame information fusion processing on the image feature of the first image and the image feature of the second image to obtain a first fused feature corresponding to the first image and a second fused feature corresponding to the second image, where the first fused feature is fused with information of the second image and the second fused feature is fused with information of the first image.

The single-frame optimization unit is configured to perform single-frame optimization processing on the image feature of the first image using the first fused feature to obtain the first optimized feature and perform single-frame optimization processing on the image feature of the second image using the second fused feature to obtain the second optimized feature.

In some possible implementations, the multi-frame fusion unit is further configured to concatenate the image feature of the first image and the image feature of the second image to obtain a first concatenated feature,

perform optimization processing on the first concatenated feature using a first residual block to obtain a third optimized feature and

perform convolution processing on the third optimized feature using two convolutional layers to obtain the first fused feature and the second fused feature respectively.

In some possible implementations, the single-frame optimization unit is further configured to perform addition processing on the image feature of the first image and the first fused feature to obtain a first added feature,

perform addition processing on the image feature of the second image and the second fused feature to obtain a second added feature and

perform optimization processing on the first added feature and the second added feature using a second residual block to obtain the first optimized feature and the second optimized feature.

In some possible implementations, the association module includes an association unit, a concatenation unit and a fusion unit.

The association unit is configured to acquire the adjacency matrix between the first optimized feature and the second optimized feature.

The concatenation unit is configured to concatenate the first optimized feature and the second optimized feature to obtain a second concatenated feature.

The fusion unit is configured to obtain the fused feature based on the adjacency matrix and the second concatenated feature.

In some possible implementations, the association unit is further configured to input the first optimized feature and the second optimized feature to a graph convolutional neural network to obtain the adjacency matrix through the graph convolutional neural network.

In some possible implementations, activation processing is performed on the adjacency matrix using an activation function, and the fused feature is obtained using a product of the adjacency matrix subjected to activation processing and the second concatenated feature.

In some possible implementations, the reconstruction unit is further configured to perform addition processing on the image feature of the first image and the fused feature to obtain an image feature of the reconstructed image and

obtain the reconstructed image corresponding to the first image using the image feature of the reconstructed image.

In some possible implementations, the image reconstruction device is used to implement at least one of image denoising processing, image super-resolution processing or image deblurring processing.

In some possible implementations, the acquisition module is further configured to, responsive to that the image reconstruction device is used to implement image super-resolution processing, perform upsampling processing on the first image and the second image and

perform feature extraction processing on the first image and second image subjected to upsampling processing to obtain the image feature corresponding to the first image and the image feature corresponding to the second image respectively.

In some embodiments, functions or modules of the device provided in the embodiment of the disclosure may be configured to perform the method described in the above method embodiment and specific implementation thereof may refer to the descriptions about the method embodiment and, for simplicity, will not be elaborated herein.

An embodiment of the disclosure also discloses a computer-readable storage medium having stored thereon computer program instructions that, when executed by a processor, cause the method to be implemented. The computer-readable storage medium may be a nonvolatile computer-readable storage medium.

An embodiment of the disclosure also discloses an electronic device, which includes a processor and a memory configured to store instructions executable by the processor, the processor being configured for the method.

The electronic device may be provided as a terminal, a server or a device in another form.

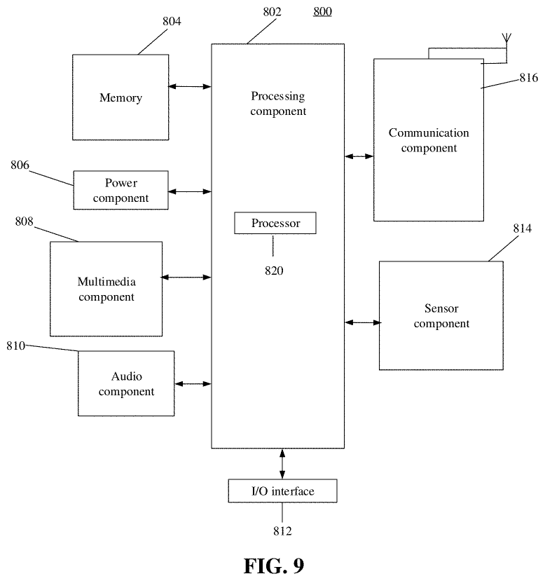

FIG. 9 is a block diagram of an electronic device according to an embodiment of the disclosure. For example, the electronic device 800 may be a terminal such as a mobile phone, a computer, a digital broadcast terminal, a messaging device, a gaming console, a tablet, a medical device, exercise equipment and a PDA.

Referring to FIG. 9, the electronic device 800 may include one or more of the following components: a processing component 802, a memory 804, a power component 806, a multimedia component 808, an audio component 810, an Input/Output (I/O) interface 812, a sensor component 814, and a communication component 816.

The processing component 802 typically controls overall operations of the electronic device 800, such as the operations associated with display, telephone calls, data communications, camera operations, and recording operations. The processing component 802 may include one or more processors 820 to execute instructions to perform all or part of the steps in the abovementioned method. Moreover, the processing component 802 may include one or more modules which facilitate interaction between the processing component 802 and the other components. For instance, the processing component 802 may include a multimedia module to facilitate interaction between the multimedia component 808 and the processing component 802.

The memory 804 is configured to store various types of data to support the operation of the electronic device 800. Examples of such data include instructions for any application programs or methods operated on the electronic device 800, contact data, phonebook data, messages, pictures, video, etc. The memory 804 may be implemented by a volatile or nonvolatile storage device of any type or a combination thereof, for example, a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic disk or an optical disk.

The power component 806 provides power for various components of the electronic device 800. The power component 806 may include a power management system, one or more power supplies, and other components associated with generation, management and distribution of power for the electronic device 800.

The multimedia component 808 includes a screen providing an output interface between the electronic device 800 and a user. In some embodiments, the screen may include a Liquid Crystal Display (LCD) and a Touch Panel (TP). If the screen includes the TP, the screen may be implemented as a touch screen to receive an input signal from the user. The TP includes one or more touch sensors to sense touches, swipes and gestures on the TP. The touch sensors may not only sense a boundary of a touch or swipe action but also detect a duration and pressure associated with the touch or swipe action. The touch sensors may not only sense a boundary of a touch or swipe action but also detect a duration and pressure associated with the touch or swipe action. The front camera and/or the rear camera may receive external multimedia data when the electronic device 800 is in an operation mode, such as a photographing mode or a video mode. Each of the front camera and the rear camera may be a fixed optical lens system or have focusing and optical zooming capabilities.

The audio component 810 is configured to output and/or input an audio signal. For example, the audio component 810 includes a Microphone (MIC), and the MIC is configured to receive an external audio signal when the electronic device 800 is in the operation mode, such as a call mode, a recording mode and a voice recognition mode. The received audio signal may further be stored in the memory 804 or sent through the communication component 816. In some embodiments, the audio component 810 further includes a speaker configured to output the audio signal.

The I/O interface 812 provides an interface between the processing component 802 and a peripheral interface module, and the peripheral interface module may be a keyboard, a click wheel, a button and the like. The button may include, but not limited to: a home button, a volume button, a starting button and a locking button.

The sensor component 814 includes one or more sensors configured to provide status assessment in various aspects for the electronic device 800. For instance, the sensor component 814 may detect an on/off status of the electronic device 800 and relative positioning of components, such as a display and small keyboard of the electronic device 800, and the sensor component 814 may further detect a change in a position of the electronic device 800 or a component of the electronic device 800, presence or absence of contact between the user and the electronic device 800, orientation or acceleration/deceleration of the electronic device 800 and a change in temperature of the electronic device 800. The sensor component 814 may include a proximity sensor configured to detect presence of an object nearby without any physical contact. The sensor component 814 may also include a light sensor, such as a Complementary Metal Oxide Semiconductor (CMOS) or Charge Coupled Device (CCD) image sensor, configured for use in an imaging application. In some embodiments, the sensor component 814 may also include an acceleration sensor, a gyroscope sensor, a magnetic sensor, a pressure sensor or a temperature sensor.

The communication component 816 is configured to facilitate wired or wireless communication between the electronic device 800 and another device. The electronic device 800 may access a communication-standard-based wireless network, such as a Wireless Fidelity (WiFi) network, a 2nd-Generation (2G) or 3rd-Generation (3G) network or a combination thereof. In an exemplary embodiment, the communication component 816 receives a broadcast signal or broadcast associated information from an external broadcast management system through a broadcast channel In an exemplary embodiment, the communication component 816 further includes a Near Field Communication (NFC) module to facilitate short-range communication. For example, the NFC module may be implemented based on a Radio Frequency Identification (RFID) technology, an Infrared Data Association (IrDA) technology, an Ultra-Wide Band (UWB) technology, a Bluetooth (BT) technology and another technology.

In the exemplary embodiment, the electronic device 800 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to perform the abovementioned method.

In the exemplary embodiment, a nonvolatile computer-readable storage medium is also provided, for example, a memory 804 including a computer program instruction. The computer program instruction may be executed by a processor 820 of an electronic device 800 to implement the abovementioned method.

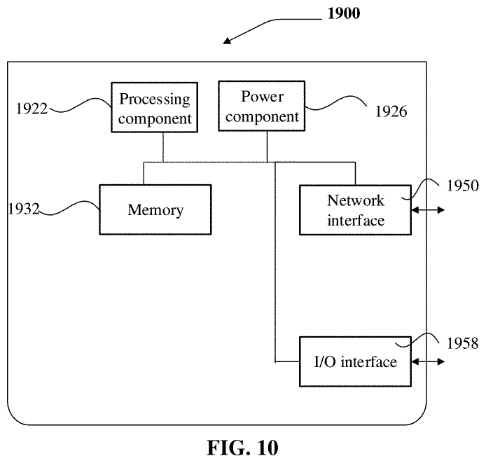

FIG. 10 is a block diagram of another electronic device according to an embodiment of the disclosure. For example, the electronic device 1900 may be provided as a server. Referring to FIG. 10, the electronic device 1900 includes a processing component 1922, further including one or more processors, and a memory resource represented by a memory 1932, configured to store instructions executable by the processing component 1922, for example, an application program. The application program stored in the memory 1932 may include one or more than one module of which each corresponds to a set of instructions. In addition, the processing component 1922 is configured to execute the instruction to perform the abovementioned method.

The electronic device 1900 may further include a power component 1926 configured to perform power management of the electronic device 1900, a wired or wireless network interface 1950 configured to concatenate the electronic device 1900 to a network and an I/O interface 1958. The electronic device 1900 may be operated based on an operating system stored in the memory 1932, for example, Windows Server™, Mac OS X™, Unix™Linux™, FreeBSD™ or the like.

In the exemplary embodiment, a nonvolatile computer-readable storage medium is also provided, for example, a memory 1932 including a computer program instruction. The computer program instruction may be executed by a processing component 1922 of an electronic device 1900 to implement the abovementioned method.

The disclosure may be a system, a method and/or a computer program product. The computer program product may include a computer-readable storage medium, in which a computer-readable program instruction configured to enable a processor to implement each aspect of the disclosure is stored.

The computer-readable storage medium may be a physical device capable of retaining and storing an instruction used by an instruction execution device. For example, the computer-readable storage medium may be, but not limited to, an electric storage device, a magnetic storage device, an optical storage device, an electromagnetic storage device, a semiconductor storage device or any appropriate combination thereof. More specific examples (non-exhaustive list) of the computer-readable storage medium include a portable computer disk, a hard disk, a Random Access Memory (RAM), a ROM, an EPROM (or a flash memory), an SRAM, a Compact Disc Read-Only Memory (CD-ROM), a Digital Video Disk (DVD), a memory stick, a floppy disk, a mechanical coding device, a punched card or in-slot raised structure with an instruction stored therein, and any appropriate combination thereof. Herein, the computer-readable storage medium is not explained as a transient signal, for example, a radio wave or another freely propagated electromagnetic wave, an electromagnetic wave propagated through a wave guide or another transmission medium (for example, a light pulse propagated through an optical fiber cable) or an electric signal transmitted through an electric wire.

The computer-readable program instruction described here may be downloaded from the computer-readable storage medium to each computing/processing device or downloaded to an external computer or an external storage device through a network such as the Internet, a Local Area Network (LAN), a Wide Area Network (WAN) and/or a wireless network. The network may include a copper transmission cable, optical fiber transmission, wireless transmission, a router, a firewall, a switch, a gateway computer and/or an edge server. A network adapter card or network interface in each computing/processing device receives the computer-readable program instruction from the network and forwards the computer-readable program instruction for storage in the computer-readable storage medium in each computing/processing device.

The computer program instruction configured to perform the operations of the disclosure may be an assembly instruction, an Instruction Set Architecture (ISA) instruction, a machine instruction, a machine related instruction, a microcode, a firmware instruction, state setting data or a source code or target code edited by one or any combination of more programming languages, the programming language including an object-oriented programming language such as Smalltalk and C++ and a conventional procedural programming language such as “C” language or a similar programming language. The computer-readable program instruction may be completely executed in a computer of a user or partially executed in the computer of the user, executed as an independent software package, executed partially in the computer of the user and partially in a remote computer, or executed completely in the remote server or a server. Responsive to that the remote computer is involved, the remote computer may be concatenated to the computer of the user through any type of network including an LAN or a WAN, or, may be concatenated to an external computer (for example, concatenated by an Internet service provider through the Internet). In some embodiments, an electronic circuit such as a programmable logic circuit, a Field-Programmable Gate Array (FPGA) or a Programmable Logic Array (PLA) may be customized using state information of a computer-readable program instruction, and the electronic circuit may execute the computer-readable program instruction, thereby implementing each aspect of the disclosure.

Herein, each aspect of the disclosure is described with reference to flowcharts and/or block diagrams of the method, device (system) and computer program product according to the embodiments of the disclosure. It is to be understood that each block in the flowcharts and/or the block diagrams and a combination of each block in the flowcharts and/or the block diagrams may be implemented by computer-readable program instructions.

These computer-readable program instructions may be provided for a universal computer, a dedicated computer or a processor of another programmable data processing device, thereby generating a machine to further generate a device that realizes a function/action specified in one or more blocks in the flowcharts and/or the block diagrams when the instructions are executed through the computer or the processor of the other programmable data processing device. These computer-readable program instructions may also be stored in a computer-readable storage medium, and through these instructions, the computer, the programmable data processing device and/or another device may work in a specific manner, so that the computer-readable medium including the instructions includes a product including instructions for implementing each aspect of the function/action specified in one or more blocks in the flowcharts and/or the block diagrams.

These computer-readable program instructions may further be loaded to the computer, the other programmable data processing device or the other device, so that a series of operating steps are executed in the computer, the other programmable data processing device or the other device to generate a process implemented by the computer to further realize the function/action specified in one or more blocks in the flowcharts and/or the block diagrams by the instructions executed in the computer, the other programmable data processing device or the other device.

The flowcharts and block diagrams in the drawings illustrate probably implemented system architectures, functions and operations of the system, method and computer program product according to multiple embodiments of the disclosure. On this aspect, each block in the flowcharts or the block diagrams may represent part of a module, a program segment or an instruction, and part of the module, the program segment or the instruction includes one or more executable instructions configured to realize a specified logical function. In some alternative implementations, the functions marked in the blocks may also be realized in a sequence different from those marked in the drawings. For example, two continuous blocks may actually be executed substantially concurrently and may also be executed in a reverse sequence sometimes, which is determined by the involved functions. It is further to be noted that each block in the block diagrams and/or the flowcharts and a combination of the blocks in the block diagrams and/or the flowcharts may be implemented by a dedicated hardware-based system configured to implement a specified function or operation or may be implemented by a combination of a special hardware and a computer instruction.

Each embodiment of the disclosure has been described above. The above descriptions are exemplary, non-exhaustive and also not limited to each disclosed embodiment. Many modifications and variations are apparent to those of ordinary skill in the art without departing from the scope and spirit of each described embodiment of the disclosure. The terms used herein are selected to explain the principle and practical application of each embodiment or technical improvements in the technologies in the market best or enable others of ordinary skill in the art to understand each embodiment disclosed herein.

1. An image reconstruction method, comprising:
acquiring an image feature corresponding to a first image in video data and an image feature corresponding to each second image adjacent to the first image;
performing feature optimization processing on the image feature of the first image and the image feature of the second image to obtain a first optimized feature corresponding to the first image and a second optimized feature corresponding to the second image respectively;
performing feature fusion processing on the first optimized feature and the second optimized feature according to an adjacency matrix between the first optimized feature and the second optimized feature to obtain a fused feature; and
performing image reconstruction processing on the first image using the fused feature to obtain a reconstructed image corresponding to the first image.

2. The method of claim 1, wherein acquiring the image feature corresponding to the first image in the video data and the image feature corresponding to each second image adjacent to the first image comprises:
acquiring at least one frame of second image at least one of directly adjacent to the first image or adjacent to the first image at an interval; and
performing feature extraction processing on the first image and the second image to obtain the image feature corresponding to the first image and the image feature corresponding to the second image respectively.

3. The method of claim 1, wherein performing feature optimization processing on the image feature of the first image and the image feature of the second image to obtain the first optimized feature corresponding to the first image and the second optimized feature corresponding to the second image respectively comprises:
performing multi-frame information fusion processing on the image feature of the first image and the image feature of the second image to obtain a first fused feature corresponding to the first image and a second fused feature corresponding to the second image, wherein the first fused feature is fused with information of the second image and the second fused feature is fused with information of the first image; and
performing single-frame optimization processing on the image feature of the first image using the first fused feature to obtain the first optimized feature, and performing single-frame optimization processing on the image feature of the second image using the second fused feature to obtain the second optimized feature.

4. The method of claim 3, wherein performing multi-frame information fusion processing on the image feature of the first image and the image feature of the second image to obtain the first fused feature corresponding to the first image and the second fused feature corresponding to the second image comprises:
concatenating the image feature of the first image and the image feature of the second image to obtain a first concatenated feature;
performing optimization processing on the first concatenated feature using a first residual block to obtain a third optimized feature; and
performing convolution processing on the third optimized feature using two convolutional layers respectively to obtain the first fused feature and the second fused feature.

5. The method of claim 3, wherein performing single-frame optimization processing on the image feature of the first image using the first fused feature to obtain the first optimized feature and performing single-frame optimization processing on the image feature of the second image using the second fused feature to obtain the second optimized feature comprises:
performing addition processing on the image feature of the first image and the first fused feature to obtain a first added feature;
performing addition processing on the image feature of the second image and the second fused feature to obtain a second added feature; and
performing optimization processing on the first added feature and the second added feature using a second residual block respectively to obtain the first optimized feature and the second optimized feature.

6. The method of claim 1, wherein performing feature fusion processing on the first optimized feature and the second optimized feature according to the adjacency matrix between the first optimized feature and the second optimized feature to obtain the fused feature comprises:
acquiring the adjacency matrix between the first optimized feature and the second optimized feature;
concatenating the first optimized feature and the second optimized feature to obtain a second concatenated feature; and
obtaining the fused feature based on the adjacency matrix and the second concatenated feature.

7. The method of claim 6, wherein acquiring the adjacency matrix between the first optimized feature and the second optimized feature comprises:
inputting the first optimized feature and the second optimized feature to a graph convolutional neural network to obtain the adjacency matrix through the graph convolutional neural network.

8. The method of claim 6, wherein obtaining the fused feature based on the adjacency matrix and the second concatenated feature comprises:
performing activation processing on the adjacency matrix using an activation function, and obtaining the fused feature using a product of the adjacency matrix subjected to activation processing and the second concatenated feature.

9. The method of claim 1, wherein performing image reconstruction processing on the first image using the fused feature to obtain the reconstructed image corresponding to the first image comprises:
performing addition processing on the image feature of the first image and the fused feature to obtain an image feature of the reconstructed image; and
obtaining the reconstructed image corresponding to the first image using the image feature of the reconstructed image.

10. The method of claim 1, wherein the image reconstruction method is used to implement at least one of image denoising processing, image super-resolution processing or image deblurring processing.

11. The method of claim 10, wherein responsive to that the image reconstruction method is used to implement image super-resolution processing, acquiring the image feature corresponding to the first image in the video data and the image feature corresponding to the second image adjacent to the first image respectively comprises:
performing upsampling processing on the first image and the second image; and
performing feature extraction processing on the first image and second image subjected to upsampling processing to obtain the image feature corresponding to the first image and the image feature corresponding to the second image respectively.

12. An image reconstruction device, comprising:
a memory storing processor-executable instructions; and
a processor configured to execute the processor-executable instructions to perform operations of:
acquiring an image feature corresponding to a first image in video data and an image feature corresponding to each second image adjacent to the first image;
performing feature optimization processing on the image feature of the first image and the image feature of the second image to obtain a first optimized feature corresponding to the first image and a second optimized feature corresponding to the second image respectively;
performing feature fusion processing on the first optimized feature and the second optimized feature according to an adjacency matrix between the first optimized feature and the second optimized feature to obtain a fused feature; and
performing image reconstruction processing on the first image using the fused feature to obtain a reconstructed image corresponding to the first image.

13. The device of claim 12, wherein acquiring the operation that the image feature corresponding to the first image in the video data and the image feature corresponding to each second image adjacent to the first image comprises:
acquiring at least one frame of second image at least one of directly adjacent to the first image or adjacent to the first image at an interval; and
performing feature extraction processing on the first image and the second image to obtain the image feature corresponding to the first image and the image feature corresponding to the second image respectively.

14. The device according to claim 12, wherein performing feature optimization processing on the image feature of the first image and the image feature of the second image to obtain the first optimized feature corresponding to the first image and the second optimized feature corresponding to the second image respectively comprises:
performing multi-frame information fusion processing on the image feature of the first image and the image feature of the second image to obtain a first fused feature corresponding to the first image and a second fused feature corresponding to the second image, wherein the first fused feature is fused with information of the second image and the second fused feature is fused with information of the first image; and
performing single-frame optimization processing on the image feature of the first image using the first fused feature to obtain the first optimized feature and performing single-frame optimization processing on the image feature of the second image using the second fused feature to obtain the second optimized feature.

15. The device of claim 14, wherein performing multi-frame information fusion processing on the image feature of the first image and the image feature of the second image to obtain the first fused feature corresponding to the first image and the second fused feature corresponding to the second image comprises:
concatenating the image feature of the first image and the image feature of the second image to obtain a first concatenated feature,
performing optimization processing on the first concatenated feature using a first residual block to obtain a third optimized feature and
performing convolution processing on the third optimized feature using two convolutional layers respectively to obtain the first fused feature and the second fused feature.

16. The device of claim 14, wherein performing single-frame optimization processing on the image feature of the first image using the first fused feature to obtain the first optimized feature and performing single-frame optimization processing on the image feature of the second image using the second fused feature to obtain the second optimized feature comprises:
performing addition processing on the image feature of the first image and the first fused feature to obtain a first added feature;
performing addition processing on the image feature of the second image and the second fused feature to obtain a second added feature; and
performing optimization processing on the first added feature and the second added feature using a second residual block respectively to obtain the first optimized feature and the second optimized feature.

17. The device of claim 12, wherein performing feature fusion processing on the first optimized feature and the second optimized feature according to the adjacency matrix between the first optimized feature and the second optimized feature to obtain the fused feature comprises:
acquiring the adjacency matrix between the first optimized feature and the second optimized feature;
concatenating the first optimized feature and the second optimized feature to obtain a second concatenated feature; and
obtaining the fused feature based on the adjacency matrix and the second concatenated feature.

18. The device of claim 17, wherein acquiring the adjacency matrix between the first optimized feature and the second optimized feature comprises:
inputting the first optimized feature and the second optimized feature to a graph convolutional neural network to obtain the adjacency matrix through the graph convolutional neural network.

19. The device of claim 17, wherein obtaining the fused feature based on the adjacency matrix and the second concatenated feature comprises:
performing activation processing on the adjacency matrix using an activation function and obtain the fused feature using a product of the adjacency matrix subjected to activation processing and the second concatenated feature.

20. A non-transitory computer-readable storage medium having stored thereon computer-executable instructions that, when executed by a processor, cause the processor to perform operations of:
acquiring an image feature corresponding to a first image in video data and an image feature corresponding to each second image adjacent to the first image;
performing feature optimization processing on the image feature of the first image and the image feature of the second image to obtain a first optimized feature corresponding to the first image and a second optimized feature corresponding to the second image respectively;
performing feature fusion processing on the first optimized feature and the second optimized feature according to an adjacency matrix between the first optimized feature and the second optimized feature to obtain a fused feature; and
performing image reconstruction processing on the first image using the fused feature to obtain a reconstructed image corresponding to the first image.
